(19) United States
(12) Patent Application Publication
(10) Pub. No.: US 2023/0258367 A1
(43) Pub. Date: Aug. 17, 2023

(54) AIR FILTER ASSEMBLY FOR HEAT RECOVERY VENTILATION UNIT

(71) Applicant: ZEHNDER GROUP INTERNATIONAL AG, GRÄNICHEN (CH)

(72) Inventor: Martijn HADDEMAN, Epe (NL)

(73) Assignee: ZEHNDER GROUP INTERNATIONAL AG, GRÄNICHEN (CH)

(21) Appl. No.: 18/016,134

(22) PCT Filed: Jul. 19, 2021
(86) PCT No.: PCT/EP2021/070132

§ 371 Date: Jan. 13, 2023

(30) Foreign Application Priority Data
Jul. 24, 2020 (CH) 921/20

(51) Int. Cl. F24F 13/28; F24F 8/108; B01D 46/52; B01D 46/00; B01D 46/42

(52) U.S. Cl. CPC F24F 13/28; F24F 8/108; B01D 46/521; B01D 46/0005; B01D 46/4227; F24F 12/00

(57) ABSTRACT

The invention relates to an air filter assembly (1) for a heat recovery ventilation unit. The air filter assembly comprises a frame (2) and a filtering element (3) fixed within said frame (2). The frame (2) comprises a first frame portion (2a) having a first height; a second frame portion (2b) opposite said first frame portion (2a) and having a second height; a third frame portion (2c); and a fourth frame portion (2d) opposite said third frame portion (2c). The third and fourth frame portions (2c, 2d) each extend between said first and second frame portions (2a, 2b). The second height is greater than the first height of said first frame portion. A height of said third frame portion (2c) is comprised between said first and second heights; and a height of said fourth frame portion (2d) is comprised between said first and second heights.

### BACKGROUND OF THE INVENTION

### Field of the Invention

The invention relates to an air filter assembly for a heat recovery ventilation unit.

### Discussion of Related Art

Filter assemblies to be used with heat recovery ventilation (HRV) units are known. Such filters assemblies comprise a filter fixed within a frame. The entire assembly can be inserted into the HRV unit in a drawer-like fashion. When the old filter is saturated, the assembly with the old filter is pulled out of the HRV unit, and an assembly with a new filter is pushed into the HRV unit. Typically, the location of a filter assembly within an HRV unit is easily accessible such that filter replacements can be carried out easily.

However, there are situations where the air filter assembly of an HRV unit is not easily accessible. A typical example is a ceiling-mounted HRV unit where the drawer-type air filter assembly is not easily accessible and filter replacement may have to be carried out above a person's head. Dust accumulated on top of the old filter to be replaced, may fall off the air filter assembly and onto the person's head or into the person's face. Besides being a nuisance, this may also constitute a health hazard for the person due to skin contact with the dust or even inhaling some of the dust.

### SUMMARY OF THE INVENTION

It is an object of the invention to make such over-the-head filter assembly replacements more comfortable and safer for a person carrying out the filter assembly replacement.

The invention provides an air filter assembly for a heat recovery ventilation unit, said air filter assembly comprising a frame and a filtering element fixed within said frame, wherein said frame comprises:
a first frame portion having a first height;
a second frame portion opposite said first frame portion and having a second height;
a third frame portion; and
a fourth frame portion opposite said third frame portion;
said third and fourth frame portions each extending between said first and second frame portions,
characterized in that
said second height is greater than said first height;
a height of said third frame portion is comprised between said first and second heights; and
a height of said fourth frame portion is comprised between said first and second heights.

Due to its first frame portion having the smallest height and its opposite second frame portion having the greatest height, the air filter assembly can be easily pushed into and pulled out of its air filtering operating position in a recess of the HRV unit. The wedge-like air filter assembly easily fits into this recess by inserting it with its first frame portion ahead.

In addition, due to the second, third and fourth frame portions all being higher than the first frame portion, all four frame portions and primarily the second, third and fourth frame portions constitute a filter frame wall around the framed surface of the filtering element. When pulling a saturated/used air filter assembly out of the recess of the HRV unit, the filter frame wall helps prevent dust accumulated on the framed surface of the filtering element from falling off and onto a person's head, thus reducing the risk of inadvertently spilling dust over the person's head during filter assembly replacement.

The height of the filter frame wall is measured with respect to the framed surface of the filtering element.

Preferably, a thickness of said filtering element is smaller than or equal to said first height of said first frame portion.

As a result, if the filtering element bottom surface is flush with the lower edges of the frame, the height of the filter frame wall corresponds to the difference between the height of the frame and the uniform thickness of the filtering element.

As a result, the air filter assembly can be easily fitted and pushed into the recess of the HRV unit, and it is less likely that dust accumulated on top of the filtering element of the air filter assembly falls onto person who changes the used air filter assembly.

Preferably, said filtering element is a pleated filter.

Preferably, at least one of said first, second, third and fourth frame portions is a straight frame portion.

Preferably, at least one straight frame portion comprises a sealing flap on its outside.

This provides a low cost sealing function between the recess and the air filter assembly inserted in the recess, thus preventing air from an air duct within the HRV unit to escape into the surrounding air or preventing air from the surrounding air to enter the air duct within the HRV unit.

Preferably, said first and second frame portions are straight frame portions extending parallel to each other.

Preferably, said third and fourth frame portions are straight frame portions extending parallel to each other.

Alternatively, at least one of said first, second, third and fourth frame portions may be a curved frame portion.

The air filter assembly may be packaged in an oversize bag, preferably an oversize polymer or plastic or paper bag.

Due to its oversize, the bag of a new air filter assembly can be easily used for receiving a saturated/used air titter assembly that has been pulled out of the recess of the HRV unit. Again, the wedge-like air filter assembly easily fits into this oversize bag when reinserting it into the bag with its first, lowest, frame portion ahead.

Preferably, the oversize bag comprises at least one glove portion or mitten portion.

When replacing a saturated/used air filter assembly, the person can grab the air filter assembly with his or her hand within the glove portion or mitten portion of the bag and then pull the air filter assembly out of the recess of the HRV unit. Of course, there is no need for the air filter assembly to be grabbed with the glove or mitten portion. The air filter assembly may be grabbed just as well without using the glove or mitten portion of the bag.

Preferably, said oversize bag comprises a left-hand glove portion or mitten portion and a right-hand glove portion or mitten portion.

When replacing a saturated/used air filter assembly, the person can grab the air filter assembly using the left or right hand within the glove portion or mitten portion of the bag and then pull the air filter assembly out of the recess of the HRV unit. Again, there is no need for the air filter assembly to be grabbed with the glove or mitten portion. The air filter assembly may be grabbed just as well without using the glove or mitten portion of the bag.

### BRIEF DESCRIPTION OF SEVERAL VIEWS OF THE DRAWINGS

FIG. 1A is a perspective view of a first embodiment of an air filter assembly according to the invention;

FIG. 1B is a side view of the first embodiment;

FIG. 2A is a perspective view of a second embodiment of the air filter assembly according to the invention; and

FIG. 2B is a side view of the second embodiment.

### DETAILED DESCRIPTION OF THE INVENTION

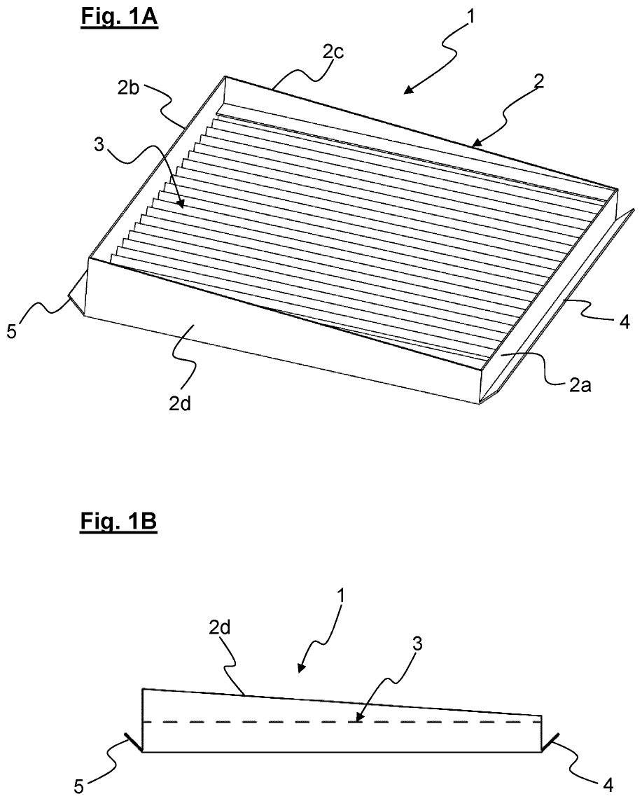

Referring to FIG. 1A, a perspective view of a first embodiment of an air filter assembly 1 according to the invention is shown. The air filter assembly 1 can be inserted in a heat recovery ventilation unit (not shown). The air filter assembly 1 comprises a frame 2 and a filtering element 3 fixed within said frame 2. The frame 2 comprises a first frame portion 2a having a first height, a second frame portion 2b opposite said first frame portion 2a and having a second height, a third frame portion 2c and a fourth frame portion 2d opposite said third frame portion 2c. The third and fourth frame portions 2c, 2d each extend between said first and second frame portions 2a, 2b. The second height of said second frame portion 2b is greater than the first height of said first frame portion 2a. A height of said third frame portion 2c is comprised between said first and second heights, and a height of said fourth frame portion 2d is comprised between said first and second heights.

The first and second frame portions 2a, 2b are straight frame portions. Each of them comprises a sealing flap 4, 5 on its outside.

The filtering element 3 is a pleated filter where the direction of the pleats is parallel to said third and fourth frame portions 2c, 2d.

Referring to FIG. 1B, a side view of the first embodiment is shown. The upper pleats of the filtering element 3 are shown as a straight dashed line.

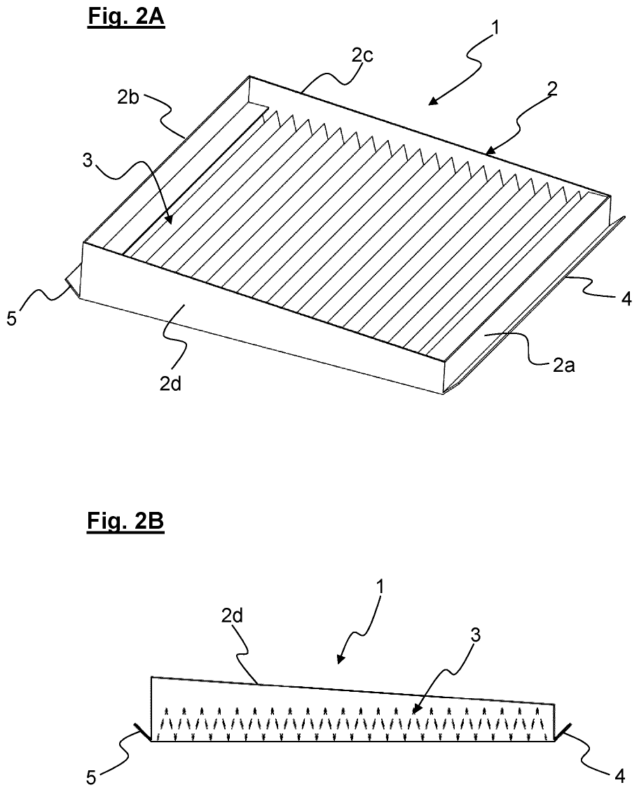

Referring to FIG. 2A, a perspective view of a second embodiment of the air filter assembly according to the invention is shown.

The second embodiment is almost identical to the first embodiment. The only difference is the direction of the pleats. The filtering element 3 is a pleated filter where the direction of the pleats is parallel to said first and second frame portions 2a, 2b.

Referring to FIG. 2B, a side view of the second embodiment is shown. The pleats of the filtering element 3 are shown as a dashed zigzag line.

1. An air filter assembly (1) for a heat recovery ventilation unit, said air filter assembly comprising a frame (2) and a filtering element (3) fixed within said frame (2), wherein said frame comprises:
a first frame portion (2a) having a first height;
a second frame portion (2b) opposite said first frame portion (2a) and having a second height;
a third frame portion (2c); and
a fourth frame portion (2d) opposite said third frame portion (2c);
said third and fourth frame portions (2c, 2d) each extending between said first and second frame portions (2a, 2b), wherein
said second height is greater than said first height of said first frame portion;
a height of said third frame portion (2c) is between said first and second heights; and
a height of said fourth frame portion (2d) is between said first and second heights.

2. The air filter assembly as defined in claim 1, wherein a thickness of said filtering element (3) is smaller than or equal to said first height of said first frame portion (2a).

3. The air filter assembly as defined in claim 1, wherein said filtering element (3) is a pleated filter.

4. The air filter assembly as defined in claim 1, wherein at least one of said first, second, third and fourth frame portions (2a, 2b, 2c, 2d) is a straight frame portion.

5. The air filter assembly as defined in claim 4, wherein said at least one straight frame portions (2a, 2b, 2c, 2d) comprises a sealing flap (4, 5) on its outside.

6. The air filter assembly as defined in claim 1, wherein said first and second frame portions (2a, 2b) are straight frame portions extending parallel to each other.

7. The air filter assembly as defined in claim 1, wherein said third and fourth frame portions (2c, 2d) are straight frame portions extending parallel to each other.

8. The air filter assembly as defined in claim 1, wherein at least one of said first, second, third and fourth frame portions is a curved frame portion.

9. The air filter assembly as defined in claim 1, further comprising oversize polymer/plastic bag enclosing the air filter assembly.

10. The air filter assembly as defined in claim 9, wherein said oversize bag comprises at least one glove portion or mitten portion.

11. The air filter assembly as defined in claim 10, wherein said oversize bag comprising a left-hand glove portion or mitten portion and a right-hand glove portion or mitten portion.
